(19) United States
(12) Patent Application Publication
(10) Pub. No.: US 2007/0247054 A1
(43) Pub. Date: Oct. 25, 2007

(54) VACUUM ENVELOPE, METHOD OF MANUFACTURING THE VACUUM ENVELOPE, AND ELECTRON EMISSION DISPLAY USING THE VACUUM ENVELOPE

(76) Inventors: Hyeong-Rae Seon, Yongin-si (KR); Dong-Su Chang, Yongin-si (KR)

Correspondence Address: CHRISTIE, PARKER & HALE, LLP, PO BOX 7068, PASADENA, CA, 91109-7068, US

(21) Appl. No.: 11/734,237

(22) Filed: Apr. 11, 2007

(30) Foreign Application Priority Data
Apr. 20, 2006 (KR) 10-2006-0035832

(51) Int. Cl. H01J 63/04; H01J 1/62

(52) U.S. Cl. 313/495

(57) ABSTRACT

A vacuum envelope includes a pair of substrates spaced apart from each other, each of the substrates having a facing portion overlapped with the other of the substrates and a non-facing portion not overlapped with the other of the substrates, a sealing member disposed between the substrates along peripheries of the facing portions, and a plurality of fixing members disposed on the non-facing portion of at least one of the substrates and contacting a side surface of the other of the substrates.

### CROSS-REFERENCE TO RELATED APPLICATION

This application claims priority to and the benefit of Korean Patent Application No. 10-2006-0035832, filed on Apr. 20, 2006, in the Korean Intellectual Property Office, the entire content of which is incorporated herein by reference.

### BACKGROUND OF THE INVENTION

1. Field of the Invention

The present invention relates to a vacuum envelope, a method of manufacturing the vacuum envelope, and an electron emission display using the vacuum envelope.

2. Description of Related Art

Electron emission elements have electron emission regions and driving electrodes for controlling an amount of electrons from the electron emission regions.

The electron emission elements are arrayed on a first substrate to form an electron emission unit. The electron emission unit is associated with a second substrate, on which a light emission unit having a phosphor layer, a black layer and an anode electrode is formed, to constitute an electron emission display.

The first and the second substrates are sealed together at their peripheries using a sealing member, and the inner space between the substrates is exhausted to form a vacuum envelope such that the emission and migration of electrons can occur smoothly. A plurality of spacers can be mounted within the vacuum envelope to space the first and the second substrates from each other by a predetermined distance under the pressure applied to the vacuum envelope.

A frit bar is used as the seating member. The frit bar is prepared by press-forming a mixture of a glass frit and an organic compound. Alternatively, a glass bar and an adhesive layer can be used as the sealing member. The adhesive layer is formed on upper and lower surfaces of the glass bar. The adhesive layer can be formed of a glass frit.

In a conventional method of manufacturing the vacuum envelope, the sealing member is disposed on one of peripheries of the first and second substrates, and one of the first and second substrates, on which the sealing member is not disposed, is aligned on the sealing member. Then, the assembly of the first and second substrates and the sealing member is loaded in a firing furnace to attach the first and second substrates to each other by melting the sealing member in a high temperature environment. Next, an exhaust pipe connected to one of the first and second substrates is connected to an exhaust device to exhaust internal air of the assembly, after which an end of the exhaust pipe is sealed, thereby completing the vacuum envelope.

However, when the first and second substrates with the sealing member interposed therebetween are aligned and loaded in the firing furnace, the first and second substrates are simply stacked on top of one another, and thus one of the first and second substrates may slip with respect to the other of the first and second substrates, or the first and second substrates may rotate relative to each other due to the thermal distortion of the assembly.

The relative rotation of the first and second substrates may cause a fatal defect of a display device where the vacuum envelope is used. That is, since a pixel is defined by an electron emission element formed on the first substrate and a phosphor layer formed on the second substrate, the first substrate must be exactly aligned with the second substrate to realize an accurate image. That is, even when the first and second substrates very slightly rotate relative to each other, some alignment defect occurs at a periphery portion of an active region.

### SUMMARY OF THE INVENTION

The present invention provides a vacuum envelope in which first and second substrates are accurately aligned with each other by preventing the first and second substrates from rotating relative to each other, a method of manufacturing the vacuum envelope, and an electron emission display using the vacuum envelope.

In an exemplary embodiment of the present invention, a vacuum envelope includes: a pair of substrates spaced apart from each other, each substrate having a facing portion overlapped with the other substrate and a non-facing portion not overlapped with the other substrate; a sealing member disposed between the substrates along peripheries of the facing portions; and a plurality of fixing members disposed on the non-facing portion of at least one of the substrates and contacting a side surface of the other of the substrates.

The fixing members may be substantially uniformly distributed along the peripheries of the facing portion.

The facing portions may have a rectangular shape and the fixing members may be respectively fixed on outer sides of four corners of the facing portions.

The fixing members may be fixed by respective adhesive layers on the non-facing portions, and the adhesive layers may have a softening point higher than that of the sealing member. Each fixing member may have a height substantially identical to a sum of a thickness of the sealing member and a thickness of the other of the substrates.

In another exemplary embodiment of the present invention, a method of manufacturing a vacuum envelope includes: arranging a pair of substrates with a sealing member interposed therebetween, such that each substrate has a facing portion overlapping with the other substrate and a non-facing portion not overlapping with the other substrate; fixing a plurality of fixing members on the non-facing portion of at least one of the substrates such that the fixing members contact a side surface of the other of the substrates, to form a substrate assembly; loading the substrate assembly in a firing furnace to attach the pair of substrates to each other by melting the sealing member; exhausting internal air out of the substrate assembly through an exhaust pipe provided on one of the substrates; and sealing the exhaust pipe.

The facing portion may have a rectangular shape and the fixing members may be respectively fixed on outer sides of four corners of the facing portions. The fixing members may be fixed by respective adhesive layers on the non-facing portions, and the adhesive layers may have a softening point higher than that of the sealing member.

In another exemplary embodiment of the present invention, an electron emission display includes: a pair of substrates spaced apart from each other, each substrate having a facing portion overlapped with the other substrate and a non-facing portion not overlapped with the other substrate; an electron emission unit disposed on one of the substrates and having a plurality of electron emission elements; a light emission unit having phosphor layers disposed on the other of the substrates to correspond to the electron emission elements; a sealing member disposed between the substrates along peripheries of the facing portions; and a plurality of fixing members provided on the non-facing portion of at least one of the substrates and contacting a side surface of the other of the substrates.

The electron emission elements may be formed with one of Field Emitter Array (FEA) elements, Surface Conduction Emitter (SCE) elements, Metal-Insulator-Metal (MIM) elements, and Metal-Insulator-Semiconductor (MIS) elements.

The light emission unit may further include black layers disposed between the phosphor layers and an anode electrode disposed on the phosphor layers and the black layers.

### BRIEF DESCRIPTION OF THE DRAWINGS

A more complete appreciation of the present invention, and many of the attendant features thereof, will be readily apparent as the present invention becomes better understood by reference to the following detailed description when considered in conjunction with the accompanying drawings, in which like reference symbols refer to like components, wherein:

FIG. 1 is a partial exploded perspective view of a vacuum envelope according to an embodiment of the present invention;

FIG. 2 is a top view of the vacuum envelope of FIG. 1, when it is assembled;

FIG. 3 is a sectional view taken along the line I-I of FIG. 2;

FIGS. 4A through 4D are schematic views of a sequential process for manufacturing a vacuum envelope according to an embodiment of the present invention;

FIG. 5 is an exploded perspective view of an electron emission display having FEA elements according to an embodiment of the present invention;

FIG. 5A is an enlarged view of an electron emission region of FIG. 5;

FIG. 6 is a partial sectional view of the electron emission display of FIG. 5; and

FIG. 7 is a partial sectional view of an electron emission display having SCE elements according to another embodiment of the present invention.

### DETAILED DESCRIPTION

Exemplary embodiments of the present invention will now be described more fully with reference to the accompanying drawings.

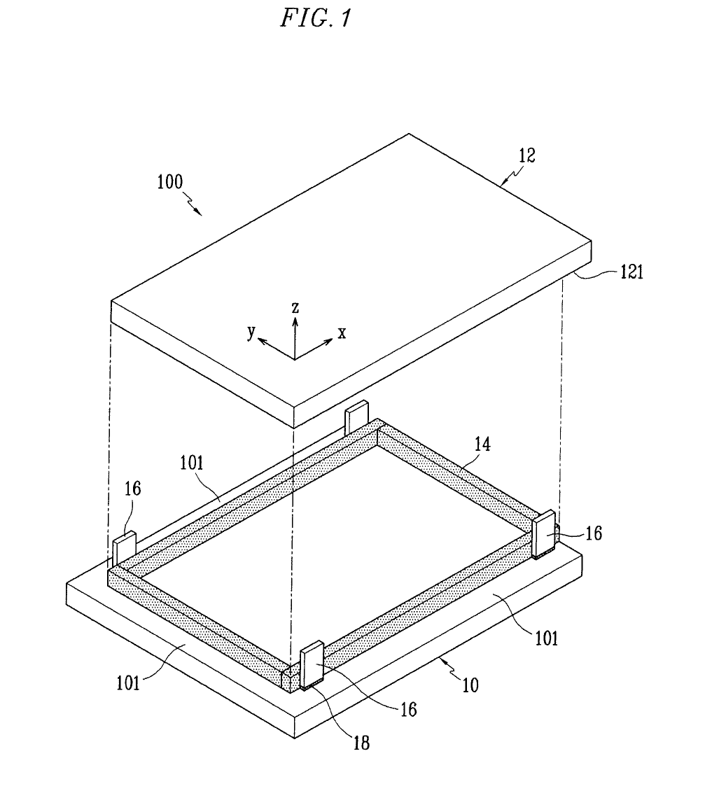

FIGS. 1, 2 and 3 show a vacuum envelope according to an embodiment of the present invention.

Referring to FIGS. 1, 2 and 3, a vacuum envelope of this embodiment includes first and second substrates 10 and 12 facing each other at a predetermined distance and a sealing member 14 provided at the peripheries of facing portions of the first and the second substrates 10 and 12, a plurality of fixing members 16 positioned on a non-facing portion of one of the first and second substrates 10 and 12 to contact a side surface of the other of the first and second substrates 10 and 12. In FIGS. 1, 2 and 3, the fixing members 16 are positioned on the first substrate 10.

The sealing member 14 can be formed of a frit bar prepared by press-forming a mixture of a glass frit and an organic compound. Alternatively, the sealing member 14 can be formed of a glass bar and an adhesive layer disposed on upper and lower surfaces of the glass bar. The first and second substrates 10 and 12 are attached to each other while the frit bar or the adhesive layer is molten in the firing process.

In this embodiment, the first and second substrates 10 and 12 are respectively provided with non-facing portions 101 and 121 on which electrode pads will be arranged. The non-facing portions 101 and 121 do not overlap with the other substrates in a thickness direction (a direction of a z-axis in FIGS. 1-3) of the vacuum envelope 100.

For example, as shown in FIGS. 1-3, the non-facing portion 101 is formed at both longitudinal side edges and at a left lateral side edge of the first substrate 10. Therefore, scan electrode pads (not shown) can be arranged on the non-facing portion 101 formed at the left lateral side edge, and data electrode pads (not shown) can be arranged on the non-facing portion 101 formed at both of the longitudinal side edges. The non-facing portion 121 is formed at a right lateral side edge of the second substrate 12 so that anode electrode pads (not shown) can be arranged on the non-facing portion 121 formed at the right lateral side edge.

When the first and second substrates 10 and 12 are aligned with each other such that they have the non-facing portions 101 and 121, respectively, the fixing members 16 are arranged on the non-facing portion 101 (or 121) of one of the first and second substrates 10 and 12 to securely contact the side surface of the other of the first and second substrates 10 and 12, thereby preventing the first and second substrates 10 and 12 from rotating relative to each other.

The fixing members 16 are fixed on one of the first and second substrates 10 and 12 (the first substrate 10 in FIG. 1) by an adhesive layer 18 such as a glass frit. The height of each fixing member 16 is greater than a thickness of the sealing member 14 so that it can contact the side surface of the second substrate 12. The height of the fixing member 16 can be equal to the sum of the thickness of the sealing member 14 and the thickness of the second substrate 12 so that the fixing member 16 can have a sufficient contacting area with the second substrate 12.

The fixing members 16 can be uniformly distributed along the peripheries of the facing portions. In this case, when a force rotating the first and second substrates 10 and 12 relative to each other is applied during the manufacturing process, the fixing member 16 uniformly supports the side surfaces of the second substrate 12, thereby preventing the first and second substrates 10 and 12 from rotating relative to each other.

For example, the fixing members 16 can be formed at outer portions of four corners of the facing portion of the first substrate 10. That is, four fixing members 16 are respectively formed at outer portions of the respective four corners of the facing portion such that the four fixing members 16 contact both longitudinal side surfaces of the second substrate 12. That is, the four fixing members 16 are fixed on the non-facing portion formed at the longitudinal side edges of the first substrate 10.

The fixing members 16 can be formed having a rectangular section. However, the present invention is not limited to this case. That is, the number and location of the fixing members are not limited to the described embodiment.

The adhesive layers 18 for attaching the fixing members 16 on the substrate are formed of a material having a softening point higher than that of the frit bar or the adhesive layer forming the sealing member 14 so that the fixing members 16 can keep their initial positions during the firing process for attaching the first and second substrates 10 and 12 to each other.

According to this embodiment, since the fixing members are formed on the non-facing portion of one of the first and second substrates, the rotation of the first and second substrates relative to each other can be prevented, thereby accurately maintaining the aligned state of the first and second substrates.

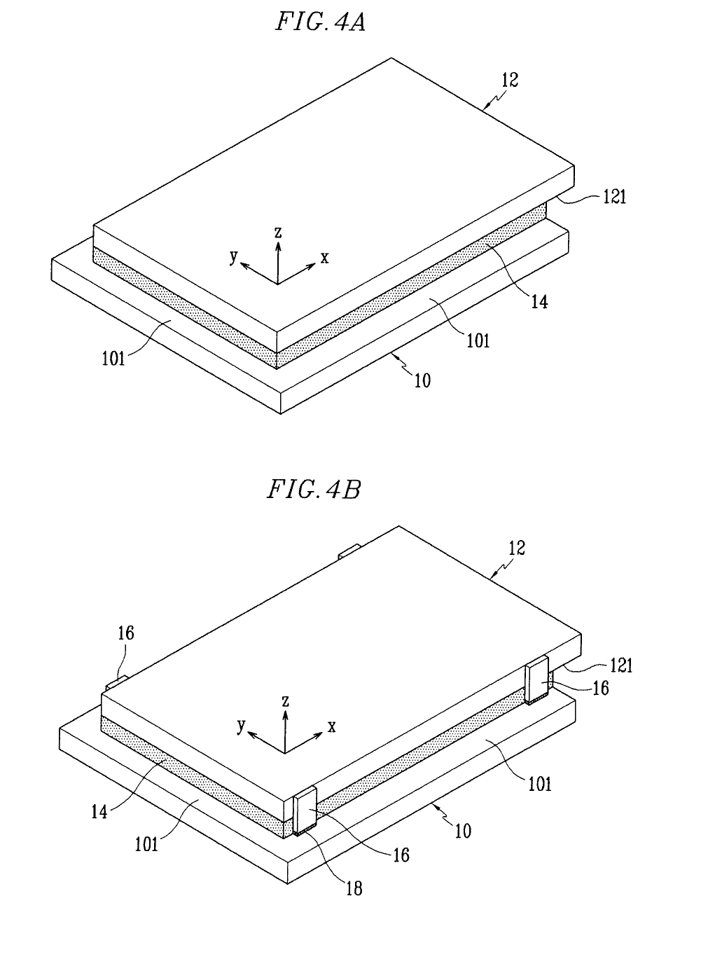

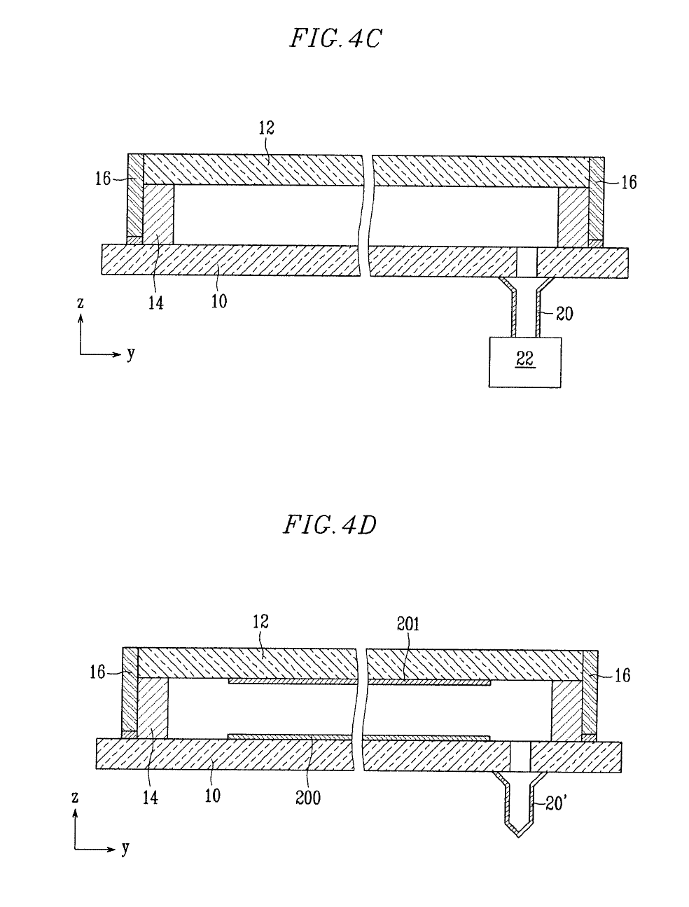

FIGS. 4A through 4D are schematic views of a sequential process for manufacturing the vacuum envelope according to an embodiment of the present invention.

Referring first to FIG. 4A, the sealing member 14 is arranged on the first substrate 10 and the second substrate 12 is aligned on the sealing member 14. At this point, the first and second substrates 10 and 12 are respectively provided with non-facing portions 101 and 121. The second substrate 12 can be provided with alignment marks (not shown) for identifying the aligned state with the first substrate 10.

Referring to FIG. 4B, the fixing members 16 are fixed on the non-facing portions 101 of the first substrate 10 using an adhesive material such as frit. For example, four fixing members 16 can be formed at outer portions of four corners of the facing portion of the first substrate 10.

Then, the resulting assembly is loaded in a firing furnace so that the first and second substrates 10 and 12 can be attached to each other by melting a surface of the frit bar or the adhesive layer.

At this point, when the first and second substrates 10 and 12 tend to slip or rotate relative to each other due to the thermal deformation thereof, the fixing members 16 suppress the relative rotation between the first and second substrates 10 and 12. Therefore, the first and second substrates 10 and 12 maintain their aligned state, which is set before the resulting assembly is loaded in the firing furnace, thereby obtaining the good alignment.

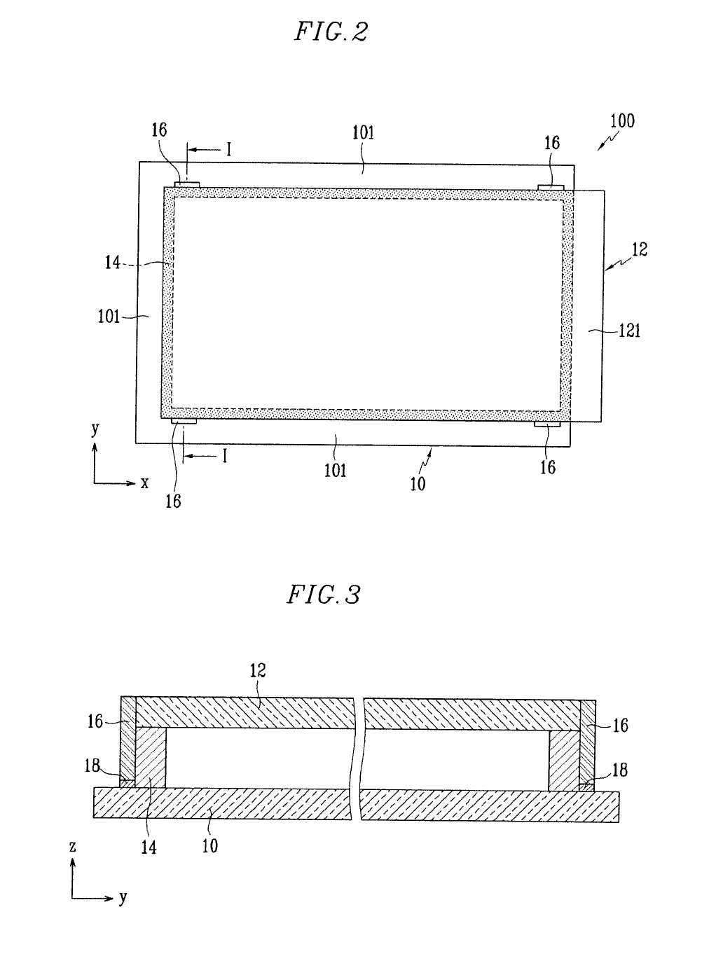

Next, referring to FIG. 4C, an exhaust pipe 20 provided on one of the first and second substrates 10 and 12 (the first substrate 10 in FIG. 4C) is connected to the exhaust device 22 to exhaust internal air out of the assembly. Then, as shown in FIG. 4D, an end of the exhaust pipe 20′ is sealed by torch-heating the end of the exhaust pipe 20′, thereby completing the vacuum envelope 100 (see FIGS. 1 and 2).

As shown in FIG. 4D, electron emission unit 200 formed by an array of electron emission elements is provided on the facing surface of the first substrate 10, and a light emission unit 201 including phosphor layers and anode electrodes is provided on the facing surface of the second substrate 12, thereby forming the electron emission display.

The electron emission elements can be FEA elements, SCE elements, MIM elements, MIS elements, or any other suitable electron emission elements known to those skilled in the art.

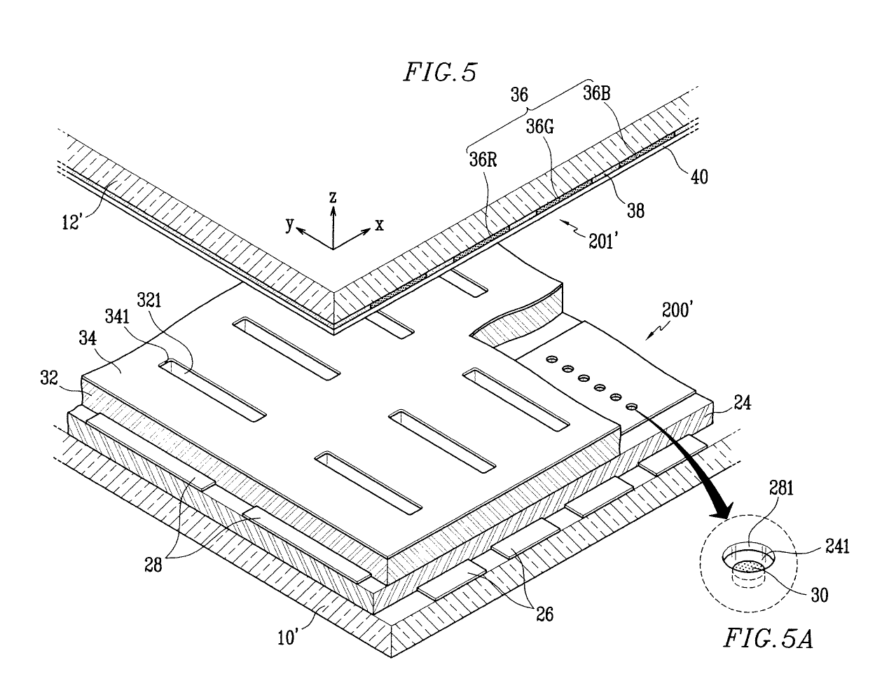

FIGS. 5, 5A and 6 show an electron emission display having FEA elements according to an embodiment of the present invention.

Referring to FIGS. 5, 5A and 6, an electron emission display of this embodiment includes an electron emission unit 200′. The electron emission unit 200′ includes cathode electrodes 26 and gate electrodes 28 crossing the cathode electrodes 26 at right angles with a first insulating layer 24 interposed therebetween. Electron emission regions 30 are formed on the cathode electrodes 26 at the crossed regions of the cathode electrodes 26 and the gate electrodes 28.

When the crossed regions of the cathode electrodes 26 and the gate electrodes 28 define pixel regions, openings 241 and 281 corresponding to the respective electron emission regions 30 are formed through the first insulating layer 24 and the gate electrodes 28 to expose the electron emission regions 30 on the first substrate 10′. FIG. 5A illustrates an enlarged view of one electron emission region 30 and the corresponding openings 241 and 281.

The electron emission regions 30 are formed of a material emitting electrons when an electric field is applied thereto under a vacuum atmosphere, such as a carbonaceous material or a nanometer-size material. The electron emission regions 30 can be formed of carbon nanotubes, graphite, graphite nanofibers, diamonds, diamond-like carbon, C₆₀, silicon nanowires, or a combination thereof.

Alternatively, the electron emission regions can be tips formed of a Mo-based or Si-based material.

Returning now to FIG. 5, a focusing electrode 34 is formed on the gate electrodes 28 and the first insulating layer 24. A second insulating layer 32 is placed under the focusing electrode 34 to insulate the focusing electrode 34 from the gate electrodes 28, and openings 341 and 321 are formed through the focusing electrode 34 and the second insulating layer 32 at the respective pixel regions to focus the electrons emitted from the respective pixel regions. Alternatively, the openings can be formed corresponding to the respective electron emission regions 30 to independently focus the electrons emitted from the respective electron emission regions 30.

The light emission unit 201′ includes phosphor layers 36 such as red (R), green (G) and blue (B) phosphor layers 36R, 36G and 36B and black layers 38 arranged between the R, G and B phosphor layers 36R, 36G and 36B to enhance the contrast of the screen. Each crossed region of the cathode electrodes 26 and the gate electrodes 28 corresponds to a single-color phosphor layer.

An anode electrode 40 formed of a metallic material such as aluminum is formed on the phosphor layers 36 and the black layers 38. The anode electrode 40 receives a high voltage required for accelerating the electron beams, and reflects the visible light rays radiated from the phosphor layers 36 toward the first substrate 10′ to the second substrate 12′, thereby increasing the screen luminance.

The anode electrode can be formed of a transparent conductive material such as indium tin oxide (ITO). In this case, the anode electrode is placed on a surface of the phosphor layers 36 and the black layers 38 facing the second substrate 12′. Furthermore, the anode electrode can be formed of a double-layered structure having a transparent conductive material-based layer and a metallic material-based layer.

As shown in FIG. 6, spacers 42 are arranged between the first and the second substrates 10′ and 12′ to support the vacuum envelope under the pressure applied thereto and maintain a gap between the first and the second substrates 10′ and 12′. The spacers 42 are located corresponding to the black layers 38 such that they do not occupy the area of the phosphor layers 36.

The electron emission display of this embodiment is driven by supplying driving voltages to the cathode, gate, focusing and anode electrodes 26, 28, 34, and 40.

For example, one of the cathode and gate electrodes 26 and 28 receives a scan driving voltage to function as a scan electrode while the other receives a data driving voltage to function as a data electrode. The focusing electrode 34 receives OV or a negative direct current voltage of several to tens of volts, and the anode electrode 40 receives a positive direct current voltage of hundreds or thousands of volts.

Then, electric fields are formed around the electron emission regions 30 due to the voltage difference between the cathode electrode 26 and the gate electrode 28, and electrons are emitted from the electron emission regions 30. The emitted electrons are focused to the center of the bundle of electron beams while passing the openings 341 of the focusing electrode 34, and attracted by the high voltage supplied to the anode electrode 40, thereby colliding against the phosphor layers 36 at the relevant pixels and causing them to emit light.

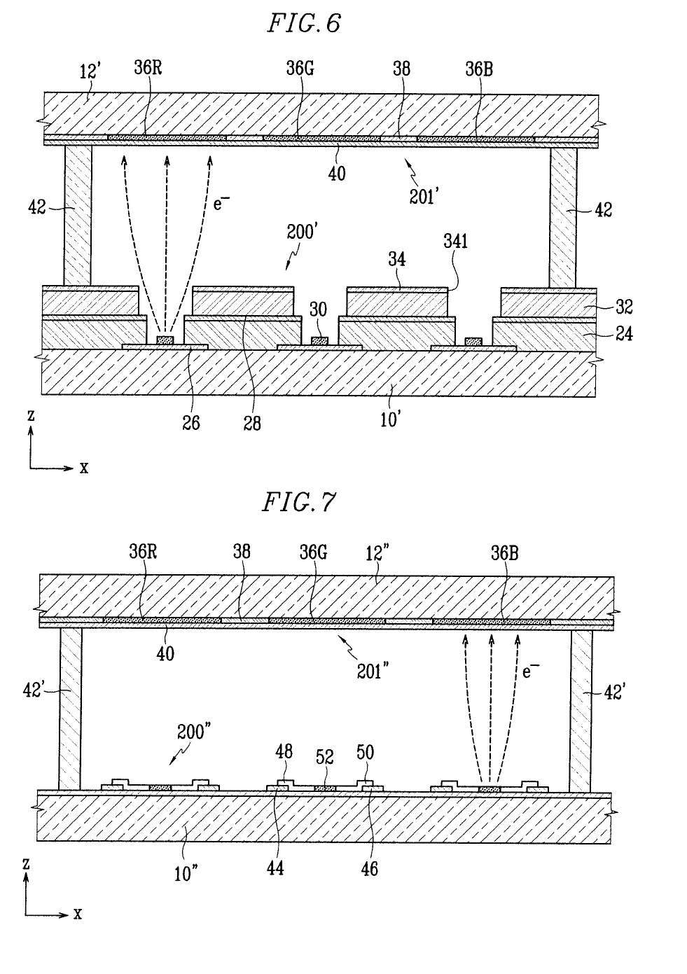

FIG. 7 is a partial sectional view of an electron emission display having SCE elements according to another embodiment of the present invention.

In an electron emission display of this embodiment, an electron emission unit 200″ includes first and second electrodes 44 and 46 arranged on a first substrate 10″ in parallel with each other and spaced apart by a predetermined distance, and first and second conductive thin films 48 and 50 placed close to each other while partially covering the surface of the first and the second electrodes 44 and 46, and electron emission regions 52 disposed between the first and the second conductive thin films 48 and 50.

The first and the second electrodes 44 and 46 can be formed of various conductive materials. The first and the second conductive thin films 48 and 50 can be formed of micro particles based on a conductive material, such as nickel, gold, platinum, and palladium.

The electron emission regions 52 can be formed of high resistance cracked portions provided between the first and the second conductive thin films 48 and 50, or can contain carbon and/or one or more carbon compounds. In the case of the latter, the electron emission regions 52 can be formed of carbon nanotubes, graphite, graphite nanofibers, diamonds, diamond-like carbon, C₆₀, silicon nanowires or a combination thereof.

A light emission unit 201″ is spaced apart from the electron emission unit 200″ at a predetermined distance by spacers 42′. Since the light emission unit 201″ is identical to the light emission unit 201′ of the electron emission display of FIGS. 5 and 6, the detailed description thereof will be omitted herein.

With the above-described structure, when predetermined driving voltages are supplied to the first and the second electrodes 44 and 46, an electric current flows through the first and the second conductive thin films 48 and 50 in a horizontal direction of the surface of the electron emission regions 52, thereby causing a surface conduction electron emission. The emitted electrons are attracted by the high voltage supplied to the anode electrode 40, and migrated toward the second substrate 12″, thereby colliding against the phosphor layers 36 at the relevant pixels and causing them to emit light.

With the above-structured electron emission display device, an electron emission unit is formed at the active area of the first substrate 10″, and a light emission unit is formed at the active area of the second substrate 12″. The first and the second substrates 10″ and 12″ are sealed together using a sealing member with support frames, adhesive layers and fillers, and the interior thereof is exhausted.

As the electron emission displays described in the foregoing embodiments have the vacuum envelope, the relative rotation between the first and second substrates 10 (or 10′ or 10″) and 12 (or 12′ or 12″) can be effectively prevented. Therefore, the electron emission unit formed on the first substrate 10 (or 10′ or 10″) can maintain an accurate alignment with the phosphor layers 36, thereby realizing a high quality image.

Although exemplary embodiments of the present invention have been described in detail hereinabove, it should be clearly understood that many variations and/or modifications of the basic inventive concept taught herein still fall within the spirit and scope of the present invention, as defined by the appended claims and equivalents thereof.

What is claimed is:

1. A vacuum envelope comprising:
a pair of substrates spaced apart from each other, each of the substrates having a facing portion overlapped with the other of the substrates and a non-facing portion not overlapped with the other of the substrates;
a sealing member disposed between the substrates along peripheries of the facing portions; and
a plurality of fixing members disposed on the non-facing portion of at least one of the substrates and contacting a side surface of the other of the substrates.

2. The vacuum envelope of claim 1, wherein the fixing members are substantially uniformly distributed along the peripheries of the facing portions.

3. The vacuum envelope of claim 2, wherein the facing portions have a rectangular shape and the fixing members are respectively fixed on outer sides of four corners of the facing portions.

4. The vacuum envelope of claim 1, wherein the fixing members are fixed by respective adhesive layers on the non-facing portions and the adhesive layers have a softening point higher than that of the sealing member.

5. The vacuum envelope of claim 1, wherein each of the fixing members has a height substantially identical to a sum of a thickness of the sealing member and a thickness of the other of the substrates.

6. The vacuum envelop of claim 1, wherein:
each of the substrates has a pair of lateral edges and a pair of longitudinal edges;
one of the substrates has the non-facing portion at one of the lateral edges and both of the longitudinal edges; and
the other of the substrates has the non-facing portion at one of the lateral edges away from the non-facing portion at the one of the lateral edges of the one of the substrates.

7. A method of manufacturing a vacuum envelope, comprising:
arranging a pair of substrates with a sealing member interposed therebetween, such that each of the substrates has a facing portion overlapping with the other of the substrates and a non-facing portion not overlapping with the other of the substrates;
fixing a plurality of fixing members on the non-facing portion of at least one of the substrates such that the fixing members contact a side surface of the other of the substrates, to form a substrate assembly;
loading the substrate assembly in a firing furnace to attach the pair of substrates to each other by melting the sealing member;
exhausting internal air out of the substrate assembly through an exhaust pipe provided on one of the substrates; and
sealing the exhaust pipe.

8. The method of claim 7, wherein the facing portions have a rectangular shape and the fixing members are respectively fixed on outer sides of four corners of the facing portions.

9. The method of claim 7, wherein the fixing members are fixed by respective adhesive layers on the non-facing portions and the adhesive layers have a softening point higher than that of the sealing member.

10. An electron emission display comprising:
a pair of substrates spaced apart from each other, each of the substrates having a facing portion overlapped with the other of the substrates and a non-facing portion not overlapped with the other of the substrates;
an electron emission unit disposed on one of the substrates and having a plurality of electron emission elements;
a light emission unit having phosphor layers disposed on the other of the substrates to correspond to the electron emission elements;
a sealing member disposed between the substrates along peripheries of the facing portions; and
a plurality of fixing members disposed on the non-facing portion of at least one of the substrates and contacting a side surface of the other of the substrates.

11. The electron emission display of claim 10, wherein the electron emission elements are formed with one of Field Emission Array (FEA) elements, Surface-Conduction Emission (SCE) elements, Metal-Insulator-Metal (MIM) elements, or Metal-Insulator-Semiconductor (MIS) elements.

12. The electron emission display of claim 10, wherein the light emission unit further comprises:
black layers disposed between the phosphor layers; and
an anode electrode disposed on the phosphor layers and the black layers.

13. The electron emission display of claim 10, wherein the facing portions have a rectangular shape and the fixing members are respectively fixed on outer sides of four corners of the facing portions.

14. The electron emission display of claim 10, wherein the fixing members are fixed by respective adhesive layers on the non-facing portions and the adhesive layers have a softening point higher than that of the sealing member.

15. The electron emission display of claim 10, wherein each of the fixing members has a height substantially identical to a sum of a thickness of the sealing member and a thickness of the other of the substrates.

16. An electron emission display comprising:
a first substrate having a first portion on which a light emission unit is disposed and a second portion;
a second substrate having a first portion on which an electron emission unit is disposed and a second portion, wherein the first portions of the substrates face each other and the second portions of the substrates do not face each other;
a sealing member disposed between the substrates along peripheries of the first portions;
a plurality of fixing members disposed on the second portion of at least one of the substrates, and adapted to prevent a relative rotation between the substrates.

17. The electron emission display of claim 16, wherein the fixing members contact a side surface of the other of the substrates.
